(19) United States
(12) Patent Application Publication
(10) Pub. No.: US 2021/0326157 A1
(43) Pub. Date: Oct. 21, 2021

(54) ONBOARDING A VNF WITH A MULTI-VNFC VDU

(71) Applicant: OPEN INVENTION NETWORK LLC, Durham, NC (US)

(72) Inventor: Keith William Melkild, Allen, TX (US)

(21) Appl. No.: 17/230,990

(22) Filed: Apr. 14, 2021

Related U.S. Application Data
(60) Provisional application No. 63/010,663, filed on Apr. 15, 2020.

(51) Int. Cl. G06F 9/455; G06F 8/70; G06F 21/64; H04L 29/08

(52) U.S. Cl. CPC G06F 9/455; H04L 67/10; G06F 21/64; G06F 8/70

(57) ABSTRACT

An example operation includes one or more of constructing a VNF package that includes one or more VDUs composed of one or more VNFCDs, generating a VNF package archive, receiving the VNF package archive containing the VNF package at an NFV MANO module, validating the VNF package archive, onboarding one or more traditional VNF package components including a file of a VNFD and at least one software artifact, onboarding one or more VNFC components associated with the one or more VDUs in the VNF package, and enabling the VNFD in a VNF Catalog.

### FIELD OF THE INVENTION

This application generally relates to onboarding of Virtual Network Functions (VNFs) in a system employing a Network Function Virtualization (NFV) architecture. More specifically, the application relates to onboarding a VNF which includes multiple Virtual Network Function Components (VNFCs) in a single Virtual Deployment Unit (VDU).

### BACKGROUND

Network Function Virtualization (NFV) based architectures offer a way to design and deploy telecommunication network services. In the past, the functions that make up these services have been tightly coupled to the proprietary hardware on which they execute. NFV based architectures decouple the software implementation of these functions from the underlying infrastructure. The software typically runs in virtual machines or containers, under the control of a hypervisor or operating system which run on commercial off-the-shelf (COTS) servers. This approach has the promise of significant reductions in capital and operational expenses for service providers as custom hardware is no longer required and scaling is provided through additional software deployments, not a provisioning of new physical equipment.

The European Telecommunications Standard Institute (ETSI) network functions virtualization (NFV) industry specification group (ISG) has defined a reference NFV architecture. ETSI took an approach that enables existing management infrastructure such as Operational Support Systems (OSS)/Business Support Systems (BSS) and Element Management Systems (EMS) to remain in place. The standard is focused on getting Network Services (NSs) and Virtual Network Functions (VNFs) deployed on a cloud-based infrastructure, while leaving traditional Fault, Configuration, Accounting, Performance and Security (FCAPS) to be managed by EMS and OSS/BSS. Even with this focus, the details of many important aspects of the functionality are not specified.

### SUMMARY

One example embodiment provides a method that includes one or more of constructing a VNF package that includes one or more VDUs composed of one or more VNFCDs, generating a VNF package archive, receiving the VNF package archive containing the VNF package at an NFV MANO module, validating the VNF package archive, onboarding one or more traditional VNF package components including a file of a VNFD and at least one software artifact, onboarding one or more VNFC components associated with the one or more VDUs in the VNF package, and enabling the VNFD in a VNF Catalog.

Another example embodiment provides a system that includes a memory communicably coupled to a process, wherein the processor is configured to perform one or more of construct a VNF package that includes one or more VDUs composed of one or more VNFCDs, generate a VNF package archive, receive the VNF package archive that contains the VNF package at an NFV MANO module, validate the VNF package archive, onboard one or more traditional VNF package components that includes a file of a VNFD and at least one software artifact, onboard one or more VNFC components associated with the one or more VDUs in the VNF package, and enable the VNFD in a VNF Catalog.

A further example embodiment provides a non-transitory computer readable medium comprising instructions, that when read by a processor, cause the processor to perform one or more of constructing a VNF package that includes one or more VDUs composed of one or more VNFCDs, generating a VNF package archive, receiving the VNF package archive containing the VNF package at an NFV MANO module, validating the VNF package archive, onboarding one or more traditional VNF package components including a file of a VNFD and at least one software artifact, onboarding one or more VNFC components associated with the one or more VDUs in the VNF package, and enabling the VNFD in a VNF Catalog.

### BRIEF DESCRIPTION OF DRAWINGS

FIG. 1 is a diagram of an embodiment of a network function virtualization framework in accordance with one or more embodiments.

FIG. 2 is a diagram of an embodiment of a VNF descriptor in accordance with one or more embodiments.

FIG. 3 is a diagram of an embodiment of a VNFC descriptor in accordance with one or more embodiments.

FIG. 4 is a diagram of an embodiment of a VNF package in accordance with one or more embodiments.

FIG. 5 is a diagram of an embodiment of a VNF package archive in accordance with one or more embodiments.

FIG. 6 is a diagram of an embodiment of a deployment of a VNF with multiple VNFCIs in a single Virtualized Container (VC).

FIG. 7 is a diagram of an embodiment of a standard hardware diagram in accordance with one or more embodiments.

FIG. 8 is a diagram of an embodiment of a VNF onboarding flow chart in accordance with one or more embodiments.

### DETAILED DESCRIPTION

In an NFV architected system, functions that were tied to specialized hardware in the past are decoupled so that their software implementations can be executed in virtualized containers running on COTS hardware. These decupled software implementations are called Virtual Network Functions (VNFs). Each of these functions is made up of one or more software components which are known as VNF Components (VNFCs). In the current architectural standards, VNFCs are mapped one to one with a virtual machine/container. A description of this mapping, which describes the VNFC software, operating system, etc. that will be deployed together, is known as a Virtual Deployment Unit (VDU). The rationale for limiting a VDU to a single VNFC is that the hosting VM or container provides limits to the underlying resources that the VNFC can consume. One downside to this approach however is the resource overhead required for each VM/container. This can be very problematic when trying to deploy a VNF onto a hardware platform with minimal resources. Another downside is the number of VMs/containers that have to be managed. Given this, there exists a need to onboard a VNF which includes a VDU that contains multiple VNFCs.

It will be readily understood that the instant components and/or steps, as generally described and illustrated in the figures herein, may be arranged and designed in a wide variety of different configurations. Thus, the following detailed description of the embodiments of at least one of a method, system, component and non-transitory computer readable medium, as represented in the attached figures, is not intended to limit the scope of the application as claimed but is merely representative of selected embodiments.

The instant features, structures, or characteristics as described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” may have been used in the description of embodiments, the application may be applied to many types of network data, such as, packet, frame, datagram, etc. The term “message” also includes packet, frame, datagram, and any equivalents thereof. Furthermore, while certain types of messages and signaling may be depicted in exemplary embodiments they are not limited to a certain type of message, and the application is not limited to a certain type of signaling.

Disclosed herein are various embodiments for implementing and/or utilizing lifecycle management of VNF components. A VNF is the implementation of a network function that can be deployed in an NFV architecture. VNFs can be viewed as service building blocks which may be used by one or more Network Services (NSs). Examples of VNFs include, but are not limited to, firewall, application acceleration, Deep Packet Inspection (DPI), Session Initiation Protocol (SIP) user agent, and Network Address Translation (NAT).

Each VNF specifies its deployment and operational behavior in a deployment template known as a VNF Descriptor (VNFD). This descriptor along with the VNF software bundle are delivered to an NFV management system in an archive known as a VNF Package. A VNF may be implemented using one or more VNF Components (VNFCs). A VNFC is an internal component of a VNF that provides a subset of that VNF's functionality. The main characteristic of a VNFC is that it maps n:1 with a Virtualized Container (VC) when the function is deployed. The term Virtualized Container (VC) is used herein to describe a Virtual Machine (VM) or operating system container. VNFCs are in turn made up of one or more software modules. Each module may spawn one or more operating system processes when deployed.

A VNF instance (VNFI) is a run-time instantiation of the VNF software resulting from completing the instantiation of its VNFCs and the connectivity between them. As multiple instances of a VNF can exist in the same domain, the terms VNF and VNF Instance (VNFI) may be used interchangeably herein. Similarly, VNFC instance (VNFCI) is a run-time instantiation of a VNFC deployed in a particular VC. It has a lifecycle dependency with its parent VNFI. As multiple instances of a VNFC can exist in the same domain, the terms VNFC and VNFC Instance (VNFCI) may also be used interchangeably herein.

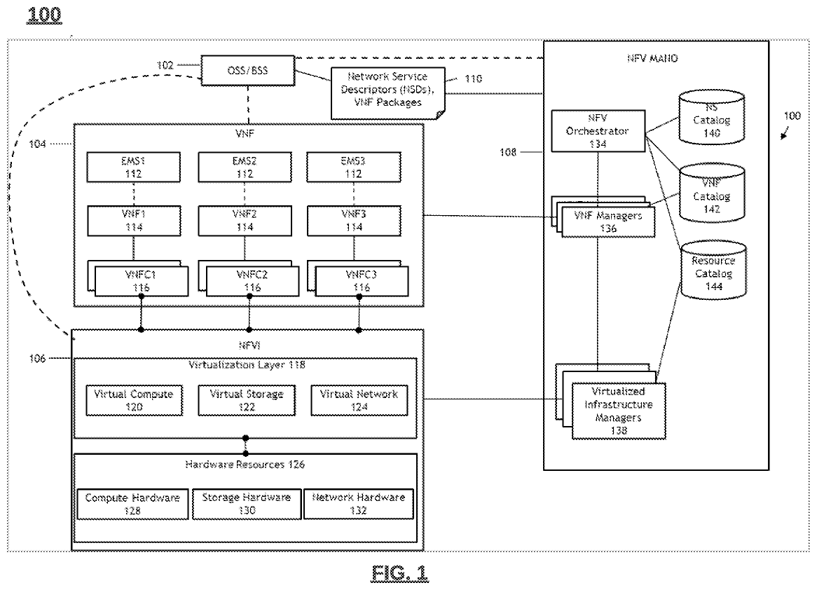

FIG. 1 is a diagram of a network function virtualization framework 100 for implementing NFV in accordance with one or more embodiments of the present application. The NFV framework 100 comprises an operating support system (OSS)/business support system (BSS) module 102, a VNF module 104, a network function virtualization infrastructure (NFVI) model 106, and an NFV management and orchestration (MANO) module 108. A module may be a virtual element, a physical network element or embedded in a physical network element and may consist of hardware, software, firmware and/or a combination of one or more of hardware, software, and firmware. The OSS/BSS module 102 is configured to support management functions such as network inventory, service provisioning, networking configurations, and fault management. Further, the OSS/BSS module 102 is configured to support end-to-end telecommunication services. The OSS/BSS module 102 is configured to interact with the VNF module 104, the NFVI module 106 and the NFV MANO module 108. The VNF module 104 may comprise element management systems (EMSs) 112, VNFs 114 and VNFCs 116. The EMSs 112 may be applicable to specific VNFs and are configured to manage one or more VNFs 114 which may be composed of one or more VNFCs 116.

In one embodiment, the VNF module 104 may correspond with a network node in a system and may be free from hardware dependency. The NFVI module 106 is configured to provide virtual compute, storage and network resources to support the execution of the VNFs. The NFVI module 106 may comprise COTS hardware, accelerator components where necessary and/or a software layer which virtualizes and abstracts underlying hardware. For example, the NFVI module 106 may comprise one or more of a virtual compute module 120, a virtual storage module 122, a virtual networking module 124 and a virtualization layer 118. The virtualization layer 118 may be operably coupled to hardware resources 126 including, but not limited to compute hardware 128, storage hardware 130 and network hardware 132. The NFV MANO module 108 is configured to orchestrate and to manage physical and/or software resources that support the infrastructure virtualization. The NFV MANO module 108 is configured to implement virtualization specific management tasks for the NFV framework 100. The NFV MANO module 108 is supplied a set of VNF packages 110 each of which includes but is not limited to a VNF Descriptor (VNFD) and a VNF software bundle. This VNFD is a set of metadata that describes VNF to VNFC structure and underlying infrastructure requirements. Additionally, the MANO module 108 may be supplied a set of Network Service Descriptors (NSDs) 110, each of which is a set of metadata that describe the relationship between services, VNFs and any underlying infrastructure requirements. The NSDs and VNF packages 110 are owned by and stored in the OSS/BSS 102, but are used to interwork with the MANO module 108.

In one embodiment, the NFV MANO module comprises an NFV orchestrator (NFVO) module 134, a VNF manager (VNFM) 136, and a virtualized infrastructure manager (VIM) 138. The NFVO 134, the VNFM 136 and the VIM 138 are configured to interact with each other. Further, the VNFM 136 may be configured to interact with and to manage the VNF module 104 and the VIM 138 may be configured to interact with and manage the NFVI module 106. The orchestrator module 134 is responsible for the lifecycle management of network services. Supported lifecycle operations include one or more of instantiating, scaling, updating and terminating network services. The VNFM 136 is responsible for the lifecycle management for a set of VNFs 114 and all of their components (VNFCs) 116. Supported lifecycle operations include one or more of instantiating, scaling, updating and terminating VNFs. A VNFM may manage one or more types of VNFs 114. The VIM 138 is responsible for controlling and managing NFVI 106 compute, storage and network resources usually within an operator's infrastructure domain. Additionally, VIMs 138 may be partitioned based on an operator's Points of Presence (PoPs), i.e., physical locations. The network service (NS) catalog 140, stores the network services which are managed by the orchestrator module 134. Each stored service may include, but is not limited to, the NSD 110 that defines the service. The VNF catalog 142 stores the VNFs which are used to build network services. Each stored VNF may include, but is not limited to, the VNF package 110 that includes the VNFD and VNF software bundle. This catalog is accessed by both the NFVO 134 and VNFM Managers 136. The resource catalog 144 stores the list of virtual and physical infrastructure resources in the NFVI 106 including the mapping between them. This catalog is accessed by both the NFVO 134 and the VIMs 138.

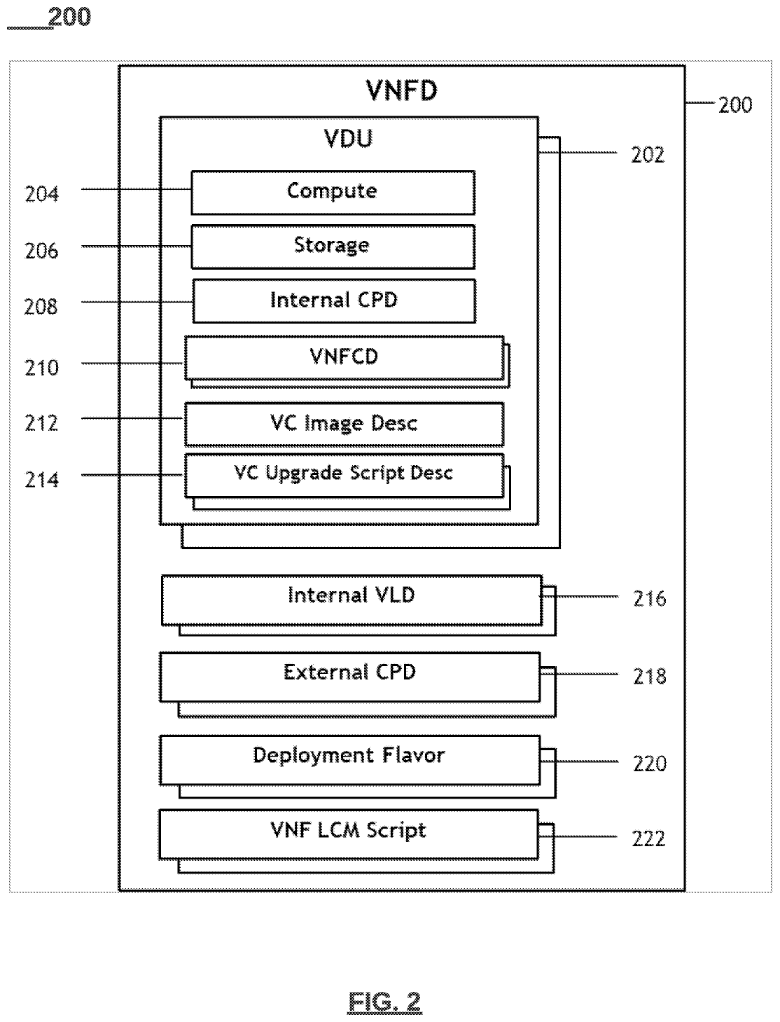

FIG. 2 illustrates a VNF Descriptor (VNFD) 200 which defines the VNF properties and requirements for onboarding and management of a VNF in an NFV system 100 (See FIG. 1) in accordance with one or more embodiments of the present application. Each VNFD 200 includes VNF identification attributes including a globally unique id, a provider identifier, a product identifier and a software version. Additionally, a VNFD includes one or more Virtual Deployment Units (VDUs) 202. Each VDU 202 may include one or more VNFCs 116 (See FIG. 1). Given this, each VDU 202 specifies the Compute 204 and Storage 206 resource requirements for running the included VNFCs. Additionally, the VDU 202 includes internal network Connection Point Descriptors (CPD) 208 which describe requirements for networking ports to be used for VNFC 114 (See FIG. 1) to VNFC communication. In accordance with one or more embodiments of the present application, each VDU includes one or more VNFC Descriptors (VNFCDs) 210 that describe the VNFCs that execute inside the VC instantiated based on this VDU 202. Further, a VC image descriptor 212 is included in the VDU 202. This image descriptor includes a reference to the location of the VC image required to install the VC that hosts the VNFCs 114 (See FIG. 1) described by the VNFCDs 210. Typically, the location reference is internal to the VNF Package 110 (See FIG. 1), but the reference may also refer to an external source. Additionally, in some embodiments, the VDU contains one or more VC Upgrade Script Descriptors 214. These scripts, which enable upgrade of the non-VNFC components of the VC, may be included if the VNFCs 116 (See FIG. 1) defined by the VNFCDs 210 are independently upgradable from the VC that hosts them.

In addition to the VDUs 202, the VNFD 200 also includes internal Virtual Link Descriptors (VLD) 216 which describe the network connectivity requirements between VNFCs within a VNF. Additionally, the VNFD 200 includes external network Connection Point Descriptors (CPD) 218 which describe requirements networking ports to be used for VNF 114 (See FIG. 1) communication. Further, the VNFD 200 includes descriptions of deployment flavors 220 which define size bounded deployment configurations related to capacity. Additionally, the VNFD 200 may include one or more VNF LCM script descriptors 222. Each VNF LCM script descriptor 222 provides a reference to a lifecycle management script included in the VNF Package 110 (See FIG. 1).

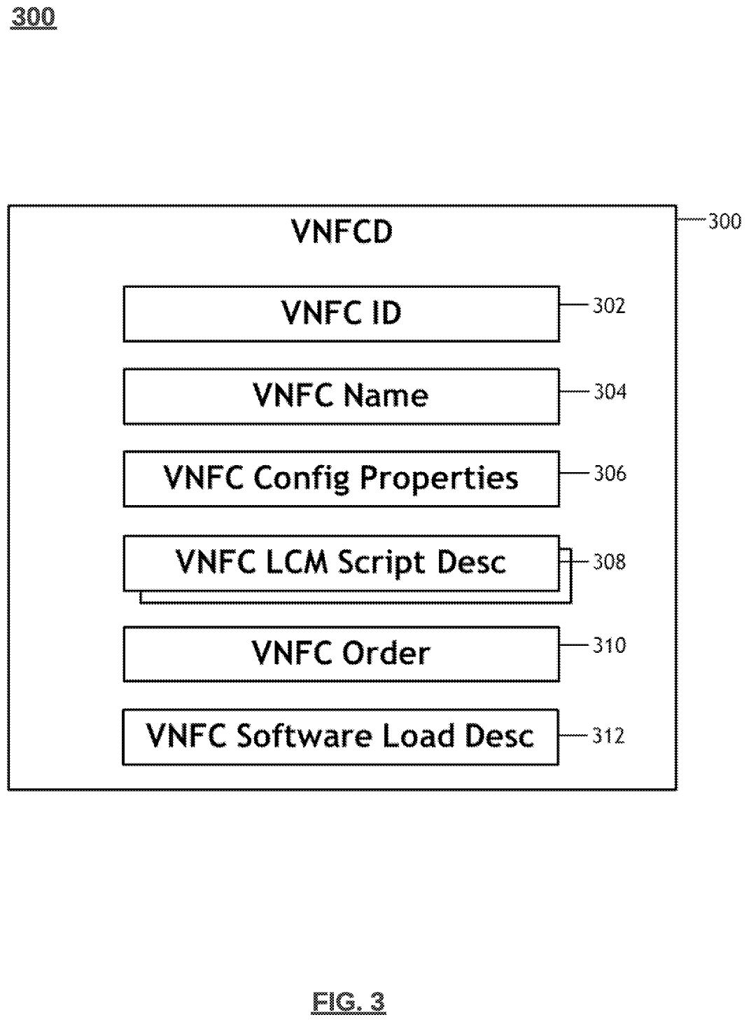

FIG. 3 illustrates a VNFC Descriptor 300 which describes a VNFC that makes up part of a VNF 114 (See FIG. 1) in accordance with one or more embodiments of the present application. The ID attribute 302 provides a unique identifier within the VNF for referencing a particular VNFC. In one embodiment this identifier 302 is used to specify a particular VNFC during a VNFC lifecycle management operation (start, stop kill, etc.). In another embodiment, this identifier 302 is used to determine the location of a VNFC-specific lifecycle management script within a VNF package 110 (See FIG. 1). Further, a VNFCD 300 may include a human readable VNFC name 304. Additionally, a VNFCD 300 may be include a set of configurable properties 306 of all VNFC instances based on this VNFCD 300. Further, a VNFC Descriptor 300 may include one or more VNFC specific lifecycle management script descriptors 308. Each LCM script descriptor 304 provides a reference to a VNFC lifecycle script included in the VNF Package 110 (See FIG. 1). Additionally, a VNFC Descriptor 300 may also include an order attribute 310. An order attribute may be used to control the start/stop order of the VNFCs during VNF lifecycle operations such as instantiate and upgrade. Further, a VNFC Descriptor 300 may also include a software load descriptor 312. A software load descriptor 312 provides a reference to a VNFC software load included in the VNF Package 110 (See FIG. 1).

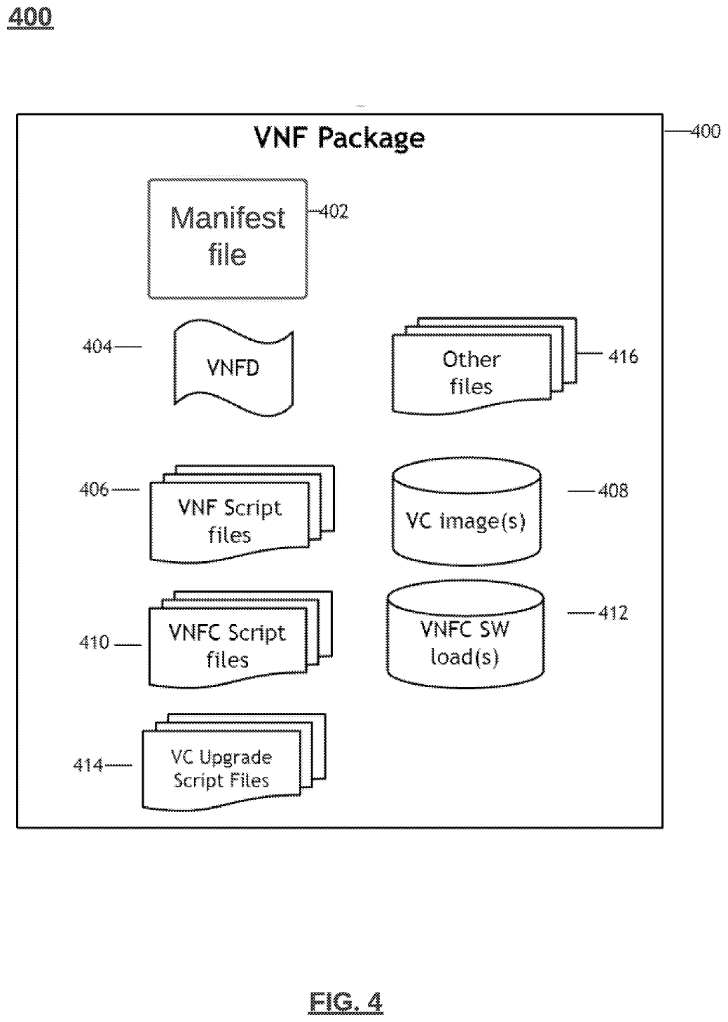

In accordance with one or more embodiments of the present application, FIG. 4 illustrates a VNF Package 400 which includes the requirements, configuration and software images required to onboard a VNF 114 (See FIG. 1) in an NFV system 100 (See FIG. 1). The VNF package is delivered by a VNF provider as a whole and is immutable. The package is digitally signed to protect it from modification. VNF Packages 400 are stored in an NS Catalog 140 (See FIG. 1) in an NFV System 100 (See FIG. 1). Each package contains a manifest file 402 which specifies the list of contents it contains. Further, the package 400 contains a VNFD 404, which as described in FIG. 3, includes the metadata for VNF onboarding and lifecycle management. Additionally, any VNF specific lifecycle management (onboard, deploy, start, etc.) scripts 406 are included. The actual binary images for each VC (VDU) 408 are also supplied. In some embodiments, a VC binary image is fully populated with the installed software of one or more VNFCs. In other embodiments, a VC binary image is populated with everything, but the software required for running the associated VNFCs. In accordance with one or more embodiments of the present application, the VNF package 400 may also contain any VNFC specific lifecycle script files 410 supplied by the VNF provider. Further, in accordance with one or more embodiments of the present application, the VNF package 400 may also contain any VNFC software loads 412 supplied by the VNF provider. These VNFC software loads 412 are useful during upgrade scenarios, as it may be desirable to upgrade an individual VNFC instead of the entire VC. It should be noted that in some embodiments, the VNFC software loads 412 are also included in the VC image binary file 408 in order to ease and expedite initial deployment. Further, in accordance with one or more embodiments of the present application, the VNF package 400 may also contain VC upgrade scripts 414 supplied by the VNF provider. These VC upgrade scripts 414 enable VC changes which may be required in order to run a newer version of one or more VNFCs. Additionally, the VNF package may include other files 416, which may consist of, but are not limited to, test files, license files and change log files.

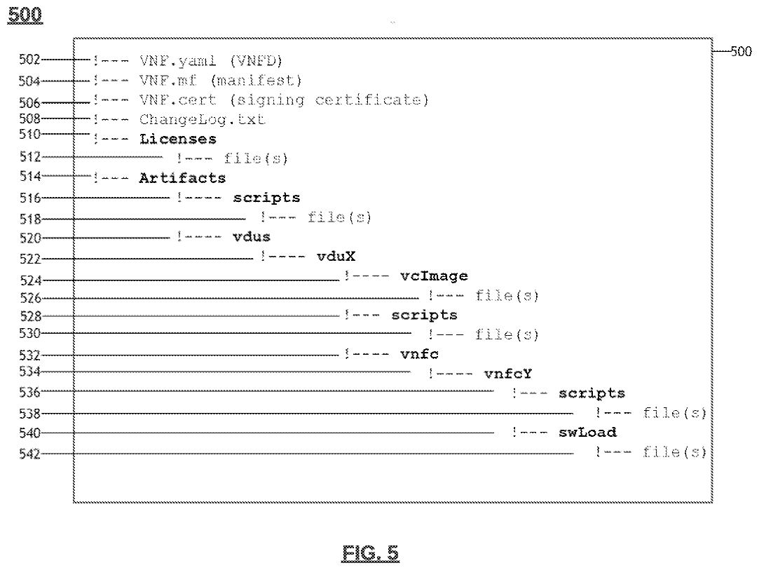

In accordance with one or more embodiments of the present application, FIG. 5 illustrates a VNF Package Archive 500 which is a compressed collection of the contents of a VNF Package 400 (See FIG. 4). In one embodiment, the Cloud Service Archive (CSAR) format is used for delivery of VNF packages 400 (See FIG. 4). A CSAR file is a zip file with a well-defined structure. In one embodiment the CSAR file structure conforms to a version of the Topology and Orchestration Specification for Cloud Application (TOSCA) standards. In one embodiment, the VNF package archive 500 conforms to a version of the TOSCA Simple Profile for NFV specification.

The exemplary VNF Package Archive 500 embodiment includes a VNFD specification file 502. In one embodiment, this file is expressed in Yet Another Modeling Language (YAML). The name of the file will reflect the VNF being delivered. Additionally, the package archive 500 may include a manifest file 504, which lists the entire contents of the archive. In one embodiment, the manifest 504 will also include a hash of each included file. Further, a signing certificate, including a VNF provider public key, may also be included 506 to enable verification of the signed artifacts in the archive 500. Additionally, a change log file 508 may be included that lists the changes between versions of the VNF. A licenses directory 510 may also be included that holds the license files 512 for all the applicable software component contained in the various software images 526. An artifacts directory 514 may be present to hold scripts and binary software images delivered in this package archive 500. Under the artifacts directory, a scripts directory 516 may be present to hold the VNF lifecycle management scripts 518.

In accordance with one or more embodiments of the present application, the archive 500 may include a hierarchical directory structure 520 for organization of all VDU artifacts under the artifacts directory 514. Under directory 520 may be a directory 522 for each specific VDU/VC. Under directory 522 may be a directory 524 for VDU/VC software image files 526. Further, under directory 522 may be a directory 528 for VDU/VC upgrade script files 530. Additionally, there may be a VNFC directory 532, which contains a directory for each specific VNFC 534 included in the VDU. In one embodiment, the name of directory 534 will match that of the ID field 302 (See FIG. 3) of the applicable VNFCD. Under each VNFC specific directory 534 may be a scripts directory 536 which contains lifecycle management script files 538 for the VNFC. Additionally, a software loads directory 540 may be present to hold VNFC software loads 542.

It should be understood that though a very hierarchical organization structure is depicted in this embodiment, other embodiments with flatter organization structures are equally applicable so long as the corresponding load and script descriptors in the VNFD 404 (See FIG. 4) reflect the correct location.

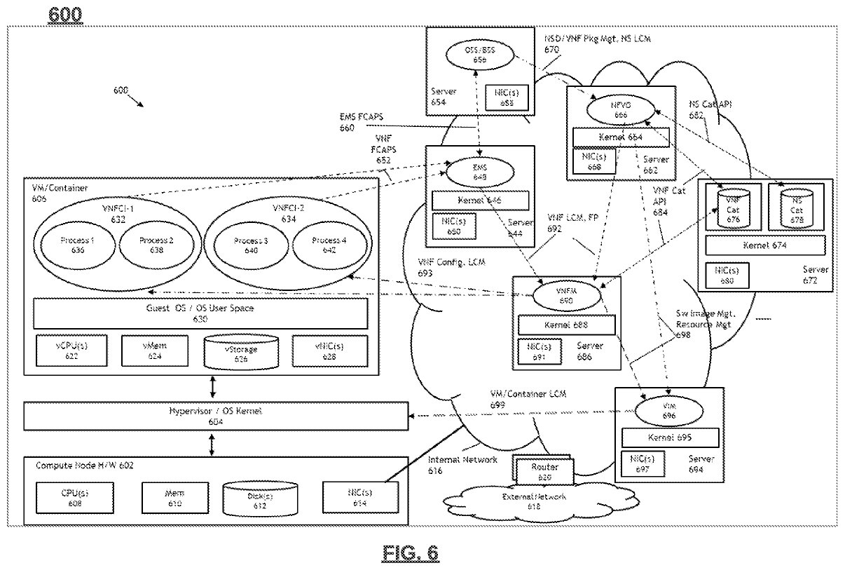

FIG. 6 illustrates an NFV deployment 600 that includes a Virtualized Container (VC) hosting multiple VNFCs in accordance with one or more embodiments of the present application. The NFV system 600 is comprised of at least one physical compute node 602. In one embodiment, the compute node 602 hosts a hypervisor 604, which in turn manages one or more Virtual Machines (VMs) 606. In another embodiment, the compute node 602, hosts an operating system (OS) kernel 604 which manage one or more containers 606. Both embodiments provide virtualization environments in which the VNF Component Instances (VNFCI) 632 and 634 reside. As the virtualization environment provided by both embodiments is sufficient for execution, the two embodiments should be considered interchangeable herein, and are referenced by the term Virtualized Container (VC). In accordance with one or more embodiments of the present application, the VNFCIs 632 and 634 execute in VC 606.

Compute node 602 is comprised of a Central Processing Unit (CPU) module 608, a memory module 610, a disk module 612 and a network interface card (NIC) module 614. As further shown in FIG. 6, NIC 614 communicate network packets via a physical internal network 616, where in accordance with one or more preferred embodiments network 616 may be a private network. The internal network may be connected to an external physical network 618 via, for example, one or more network routers 620.

Each VC 606 is comprised of a series of virtual resources that map to a subset of the physical resources on the compute nodes 602. Each VC is assigned one or more virtual CPUs (vCPUs) 622, an amount of virtual memory (vMem) 624, an amount of virtual storage (vStorage) 626 and one or more virtual NICs (vNIC) 628. A vCPU 622 represents a portion or share of a physical CPU 608 that are assigned to a VM or container. A vMem 624 represents a portion of volatile memory (e.g. Random Access Memory) 610 dedicated to a VC. The storage provided by physical disks 612 are divided and assigned to VCs as needed in the form of vStorage 626. A vNIC 628 is a virtual NIC based on a physical NIC 614. Each vNIC is assigned a media access control (MAC) address which is used to route packets to an appropriate VC. A physical NIC 614 can host many vNICs 628.

In the case of a VM, a complete guest operating system 630 runs on top of the virtual resources 622-628. In the case of an operating system container, each container includes a separate operating system user space 630, but shares an underlying OS kernel 604. In either embodiment, typical user space operating system capabilities such as secure shell and service management are available.

One or more VNFC instances (VNFCIs) 632 and 634 may reside in VC 606. In accordance with one or more embodiments of the present application, the VNFCIs 632 and 634 are instances of different types of VNFCs. In some embodiments the VNFCIs 632-634 are composed of multiple operating system processes 636-642. In one embodiment each VNFCI 632 or 634 may be installed and managed as an operating system service. In another embodiment, a VNFCI 632 or 634 may be managed by a local NFV based software agent.

In one embodiment, a server 644, running a virtualization layer with a shared kernel 646, provides one or more VCs, at least one of which hosts an EMS 648 which is responsible for one or more of the fault, configuration, accounting, performance and security (FCAPS) services of one or more VNFCIs 632-634. The server 644 has one or more NICs 650 which provide connectivity to an internal network 616 over which all incoming and outgoing messages travel. There may be many EMSs in a system 600. An EMS 648 sends and receives FCAPS messages 652 to/from all VNFCIs 632-634 that it is managing.

In one embodiment, a server 654 hosts an OSS/BSS 656 which is responsible for managing an entire network. It is responsible for consolidation of fault, configuration, accounting, performance and security (FCAPS) from one or more EMSs 648. The server 654 has one or more NICs 658 which provide connectivity to an internal network 616 over which all incoming and outgoing messages travel. The OSS/BSS 656 exchanges FCAPS messages 660 to maintain a network wide view of network faults, performance, etc. Additionally, the OSS/BSS 656 understands and manages connectivity between elements (VNFCIs in this case), which is traditionally beyond the scope of an EMS 648. In accordance with one or more embodiments of the present application, an OSS/BSS 656 also manages network services and VNFs through an NFV Orchestrator (NFVO) 666.

In accordance with one or more embodiments of the present application, a server 662, running a virtualization layer with a shared kernel 664, provides one or more VCs, at least one of which hosts an NFVO 666. The server 662 has one or more NICs 668 which provide connectivity to an internal network 616 over which all incoming and outgoing messages travel. The NFVO 666 provides the execution of automated sequencing of activities, task, rules and policies needed for creation, modification, removal of network services or VNFs. Further, the NFVO 666 provides an API 670 which is usable by other components for network service and VNF lifecycle management (LCM).

In accordance with one or more embodiments of the present application, a server 672, running a virtualization layer with a shared kernel 674, provides one or more VCs, hosting one or more catalogs used by the NFVO 666. These include, but are not limited to, a Network Services (NS) Catalog 676 and a VNF Catalog 678. The server 672 has one or more NICs 680 which provide connectivity to an internal network 616 over which all incoming and outgoing messages travel. The NS Catalog 676 maintains a repository of all on-boarded Network Services. The NS Catalog 676 provides a catalog interface 682 that enables storage and retrieval of Network service templates, expressed as Network Service Descriptors (NSDs). The VNF Catalog 678 maintains a repository of all on-boarded VNF packages. In one embodiment VNF packages are provided in accordance with VNF Package format 400 (see FIG. 4). The VNF Catalog 678 provides a catalog interface 684 that enables storage and retrieval of VNF package artifacts such as VNF Descriptors (VNFD) 404, software images 412, manifest files 402, etc. This interface is utilized by both the NFVO 666 and the VNFM 690 when performing VNF lifecycle operations.

In accordance with one or more embodiments of the present application, a server 686 running a virtualization layer with a shared kernel 688, provides one or more VCs, at least one of which hosts an VNFM 690. The server 686 has one or more NICs 691 which provide connectivity to an internal network 616 over which all incoming and outgoing messages travel. The VNFM 690 supports VNF configuration and lifecycle management. Further it provides interfaces 692 for these functions that the NFVO 666 utilizes to instantiate, start, stop, etc. VNFs. In one embodiment, the VNFM 690 retrieves VNF package archives 500 (See FIG. 5) or package contents 502-542 (See FIG. 5) directly from an VNF Catalog 676 in order to instantiate a VNF. In another embodiment, the VNFM 690 caches VNF package archives 500 (See FIG. 5) or package contents 502-542 (See FIG. 5) managed VNFs for efficient access. In a preferred embodiment, VNF LCM interface 692 provide additional commands for LCM of individual VNFCs 632-634. Further, once a VNF is instantiated, the VNFM 690 may control, monitor, and update its configuration based on interfaces 693 that it is required to provide. As each VNF is comprised of one or more VNFCIs 632-634, the configuration and monitoring interface is implemented on at least one of the VNFCIs 632 or 634. Given this, the interfaces 693 are instantiated in one or more VNFCIs 632-634.

In accordance with one or more embodiments of the present application, a server 694 running a virtualization layer with a shared kernel 695, provides one or more VCs, at least one of which hosts a VIM 696 which is responsible for managing the virtualized infrastructure of the NFV System 600. The server 694 has one or more NICs 697 which provide connectivity to an internal network 616 over which all messages travel. There may be many VIMs 696 in a system 600. The VIM 696 provides resource management interfaces 698 which are utilized by the VNFM 690 and the NFVO 666. In a preferred embodiment, the VIM 696 extracts and caches VC images stored in VNF Packages archives 500 (See FIG. 5) in order expedite the deployment process. In order to fulfill a resource management request, a VIM 696 may need to manage a compute node 602, hypervisor/OS 604, VM 606, network 616 switch, router 620 or any other physical or logical element that is part of the NFV System 600 infrastructure. In one embodiment, a VIM 696 utilizes a container/VM lifecycle management interface 699 provided by the hypervisor/OS kernel in order to process an LCM request from a VNFM 690. In another embodiment, a VIM 696 will query the states of requisite logical and physical elements when a resource management request 698 is received from a VNFM 690 or NFVO 666. This embodiment may not be efficient however given the elapsed time between state requests and responses. In another embodiment, a VIM 696 will keep a current view of the states of all physical and logical elements that it manages in order to enable efficient processing when element states are involved. Further, in some embodiments a VIM 696 updates the NFVO 666 about resource state changes using the resource management interface 698.

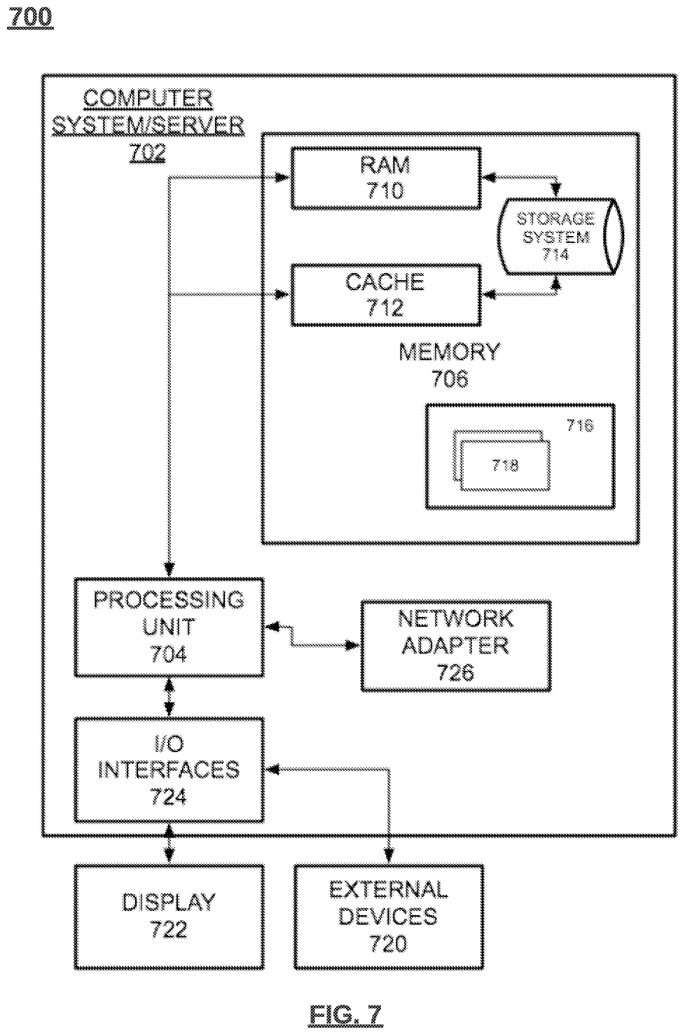

FIG. 7 illustrates one example of a computing node 700 to support one or more of the example embodiments. This is not intended to suggest any limitation as to the scope of use or functionality of the embodiments described herein. Regardless, the computing node 700 is capable of being implemented and/or performing any of the functionalities or embodiments set forth herein.

In computing node 700 there is a computer system/server 702, which is operational with numerous other general purpose or special purpose computing system environments or configurations. Examples of well-known computing systems, environments, and/or configurations that may be suitable for use with computer system/server 702 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 702 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 702 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, computer system/server 702 in cloud computing node 700 is shown in the form of a general-purpose computing device. The components of computer system/server 702 may include, but are not limited to, one or more processors or processing units 704, a system memory 706, and a bus 708 that couples various system components including system memory 706 to processor 704.

Bus 708 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 702 typically includes a variety of computer system readable media. Such media may be any available media that is accessible by computer system/server 702, and it includes both volatile and nonvolatile media, removable and non-removable media.

The system memory 706 can include computer system readable media in the form of volatile memory, such as random access memory (RAM) 710 and/or cache memory 712. Computer system/server 702 may further include other removable/non-removable, volatile/non-volatile computer system storage media. By way of example only, storage system 714 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CDROM, DVD-ROM or other optical media can be provided. In such instances, each can be connected to bus 708 by one or more data media interfaces. As will be further depicted and described below, memory 706 may include at least one program product having a set (e.g., at least one) of program modules that are configured to carry out the functions of various embodiments as described herein.

Program/utility 716, having a set (at least one) of program modules 718, may be stored in memory 706 by way of example, and not limitation, as well as an operating system, one or more application programs, other program modules, and program data. Each of the operating system, one or more application programs, other program modules, and program data or some combination thereof, may include an implementation of a networking environment. Program modules 718 generally carry out the functions and/or methodologies of various embodiments as described herein.

Aspects of the various embodiments described herein may be embodied as a system, method, component or computer program product. Accordingly, aspects of the embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the embodiments may take the form of a computer program product embodied in one or more computer readable medium(s) having computer readable program code embodied thereon.

Computer system/server 702 may also communicate with one or more external devices 720 such as a keyboard, a pointing device, a display 722, etc.; one or more devices that enable a user to interact with computer system/server 702; and/or any devices (e.g., network card, modem, etc.) that enable computer system/server 702 to communicate with one or more other computing devices. Such communication can occur via I/O interfaces 724. Still yet, computer system/server 702 can communicate with one or more networks such as a local area network (LAN), a general wide area network (WAN), and/or a public network (e.g., the Internet) via network adapter 726. As depicted, network adapter 726 communicates with the other components of computer system/server 702 via bus 708. It should be understood that although not shown, other hardware and/or software components could be used in conjunction with computer system/server 702. Examples, include, but are not limited to: microcode, device drivers, redundant processing units, external disk drive arrays, RAID systems, tape drives, and data archival storage systems, etc.

In general, the routines executed to implement the embodiments, whether implemented as part of an operating system or a specific application; component, program, object, module or sequence of instructions will be referred to herein as “computer program code”, or simply “program code”. The computer program code typically comprises one or more instructions that are resident at various times in various memory and storage devices in a computer, and that, when read and executed by one or more processors in a computer, causes that computer to perform the steps necessary to execute steps or elements embodying the various aspects of the embodiments. Moreover, while the embodiments have and herein will be described in the context of fully functioning computers and computer systems, the various embodiments are capable of being distributed as a program product in a variety of forms, and that the embodiments apply equally regardless of the particular type of computer readable media used to actually carry out the distribution. Examples of computer readable media include but are not limited to physical, recordable type media such as volatile and non-volatile memory devices, floppy and other removable disks, hard disk drives, optical disks (e.g., CD-ROM's, DVD's, etc.), among others, and transmission type media such as digital and analog communication links.

In addition, various program code described herein may be identified based upon the application or software component within which it is implemented in specific embodiments. However, it should be appreciated that any particular program nomenclature used herein is merely for convenience, and thus the embodiments should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, APIs, applications, applets, etc.), it should be appreciated that the embodiments are not limited to the specific organization and allocation of program functionality described herein.

The exemplary environment illustrated in FIG. 7 is not intended to limit the present embodiments. Indeed, other alternative hardware and/or software environments may be used without departing from the scope of the embodiments described herein.

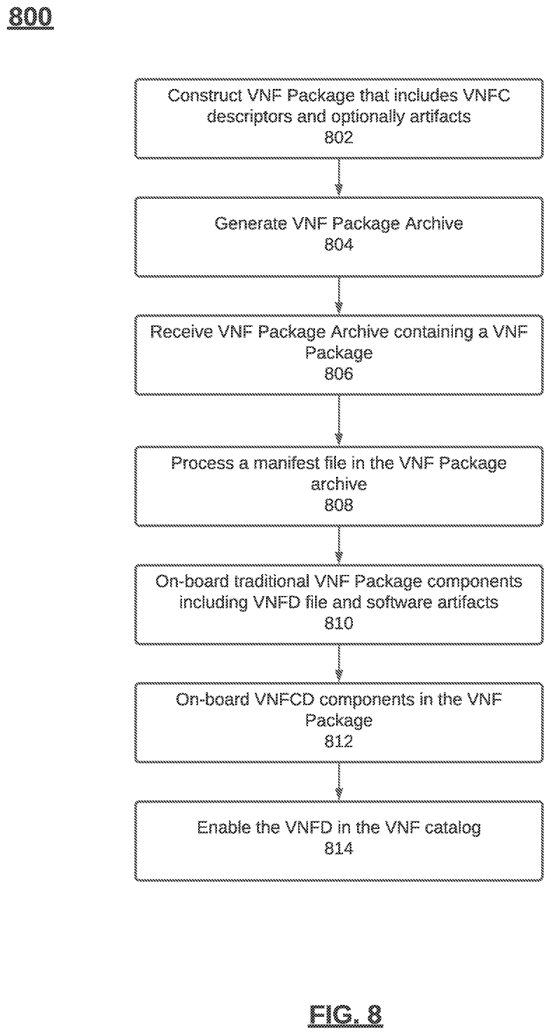

In accordance with one or more embodiments of the present application, FIG. 8 illustrates a VNF onboarding process 800 for a VNF which include one or more VDUs composed of multiple VNFCs. A VNF provider constructs a VNF package 802 that includes at least one of a VNFD 200 (See FIG. 2) with one or more VNFC descriptors 300 (See FIG. 3) or one or more VNFC artifacts 410-412 (See FIG. 4). In one embodiment, the VNFD is constructed as described in FIG. 2. In some embodiments, the VNFC descriptors are constructed as described in FIG. 3. In one embodiment, the VNF Package includes one or more VNFC lifecycle management scripts 410 (See FIG. 4). In another embodiment, the VNF package includes one or more VNFC software loads 412 (See FIG. 4).

Once the VNF package 400 (See FIG. 4) has been constructed, the VNF provider generates an archive 804 that contains the contents in compliance with the requirements of the destination NFVO 666 (See FIG. 6)/134 (See FIG. 1). In accordance with one or more embodiments of the present application, the archive may reflect the exemplary embodiment depicted in FIG. 5. In one embodiment, the archive may be in the Cloud Service Archive (CSAR) format.

In step 806, an NFVO 666 (See FIG. 6) receives the VNF Package Archive 500 (See FIG. 5) from a VNF Provider which includes a VNF Package 400 (See FIG. 4). In one embodiment, the archive is received by a package management system included within the NFVO 666 (See FIG. 6). Once the package archive is received by the NFVO 666 (See FIG. 6), the manifest file 504 (See FIG. 5) is located and processed 808. If the manifest file is not found, then processing of the archive ceases. If it is found, then the signing certificate 506 (See FIG. 5) is processed. Additionally, the NFVO 666 (See FIG. 6) may perform other security checks based on checksum, digest, etc. files contained in the archive against the trusted manifest file.

In step 810, the NFVO 666 (See FIG. 6)/134 (See FIG. 1) on-boards the traditional VNF package components. The VNFD file 502 (See FIG. 5) is first located and extracted from the VNF Package Archive 500 (See FIG. 5). In one embodiment, the NFVO may process the identification attributes in the VNFD file 502 (See FIG. 5), to see if the VNFD 200 (See FIG. 2) has been previously on-boarded into the VNF catalog 676 (See FIG. 6). If the VNF identifier plus version are identical to what is in the catalog, then the VNF Provider may be prompted to confirm whether or not to continue, as this will result in a VNF package overwrite. If a VNFD file 502 (See FIG. 5) under the same identification attributes is found, but the version is newer, then the NFVO 666 (See FIG. 6) may process this as a package update instead of as a package addition. In accordance with one or more embodiments of the present application, the VNFD file 502 (See FIG. 5) may include one or more VNFC descriptors 212 (See FIG. 2).

Once the VNFD file 502 (See FIG. 5) is on-boarded, additional VNF package components 406-414 (See FIG. 4) are located and processed. In some embodiments, the NFVO 666 (See FIG. 6) loads VNFC software images and/or lifecycle management scripts 406-408 (See FIG. 4). In one embodiment, these artifacts are extracted from the archive 500 (See FIG. 5) and stored along with the VNFD file in the VNF catalog 676 (See FIG. 6). In another embodiment, one or more of these artifacts may be stored in another database, and an external reference is added to the VNF entry in the VNF catalog 676 (See FIG. 6). In some cases, the VC software image reference 210 (See FIG. 2) may specify an external source. In such an embodiment, the software image may be uploaded from the source and stored in the VNF catalog 676 (See FIG. 6) for efficient, localized access.

In step 812, and in accordance with one or more embodiments of the present application, VNFC components/artifacts are located and processed. In some embodiments, the NFVO 666 (See FIG. 6) loads VNFC software loads and/or lifecycle management scripts 410-412 (See FIG. 4). In one embodiment, these components/artifacts are extracted from the archive 500 (See FIG. 5) and stored along with the VNFD file in the catalog 676 (See FIG. 6). In another embodiment, one or more of these artifacts may be stored in another database, and an external reference is added to the VNF entry in the VNF catalog 676 (See FIG. 6). In some cases, the VNFC software load reference 312 (See FIG. 3) may specify an external source. In such an embodiment, the software load may be uploaded from the source and stored in the VNF catalog 676 (See FIG. 6) for efficient, localized access.

In step 814, the VNFD in enabled in the VNF catalog 676 (See FIG. 6). In some embodiments, the NFVO 666 (See FIG. 6)/134 (See FIG. 1) automatically enables the VNFD once the on-boarding process has completed.

What is claimed is:

1. A method, comprising:
constructing a VNF package that includes one or more VDUs composed of one or more VNFCDs;
generating a VNF package archive;
receiving the VNF package archive containing the VNF package at an NFV MANO module;
validating the VNF package archive;
onboarding one or more traditional VNF package components including a file of a VNFD and at least one software artifact;
onboarding one or more VNFC components associated with the one or more VDUs in the VNF package; and
enabling the VNFD in a VNF Catalog.

2. The method of claim 1, wherein the VNF package archive is in a Cloud Service Archive (CSAR) format.

3. The method of claim 1, wherein the VNF package includes one or more VNFC lifecycle management scripts.

4. The method of claim 1, wherein the VNF package includes one or more VNFC software loads.

5. The method of claim 1, wherein the VNF Package is validated by at least one of a signing certificate, a trusted manifest, and a checksum.

6. The method of claim 1, wherein the traditional VNF package components are stored in the VNF Catalog.

7. The method of claim 1, wherein the one or more VNFC components are a reference to an artifact stored in an external database.

8. A system, comprising:
a processor and a memory communicably coupled to the processor, wherein the processor is configured to perform one or more of:
construct a VNF package that includes one or more VDUs composed of one or more VNFCDs;
generate a VNF package archive;
receive the VNF package archive that contains the VNF package at an NFV MANO module;
validate the VNF package archive;
onboard one or more traditional VNF package components that includes a file of a VNFD and at least one software artifact;
onboard one or more VNFC components associated with the one or more VDUs in the VNF package; and
enable the VNFD in a VNF Catalog.

9. The system of claim 8, wherein the VNF package archive is in a Cloud Service Archive (CSAR) format.

10. The system of claim 8, wherein the VNF package includes one or more VNFC lifecycle management scripts.

11. The system of claim 8, wherein the VNF package includes one or more VNFC software loads.

12. The system of claim 8, wherein the VNF Package is validated by at least one of a signing certificate, a trusted manifest, and a checksum.

13. The system of claim 8, wherein the traditional VNF package components are stored in the VNF Catalog.

14. The system of claim 8, wherein the one or more VNFC components are a reference to an artifact stored in an external database.

15. A non-transitory computer readable medium comprising instructions, that when read by a processor, cause the processor to perform:
constructing a VNF package that includes one or more VDUs composed of one or more VNFCDs;
generating a VNF package archive;
receiving the VNF package archive containing the VNF package at an NFV MANO module;
validating the VNF package archive;
onboarding one or more traditional VNF package components including a file of a VNFD and at least one software artifact;
onboarding one or more VNFC components associated with the one or more VDUs in the VNF package; and
enabling the VNFD in a VNF Catalog.

16. The non-transitory computer readable medium of claim 15, wherein the VNF package archive is in a Cloud Service Archive (CSAR) format.

17. The non-transitory computer readable medium of claim 15, wherein the VNF package includes one or more VNFC lifecycle management scripts.

18. The non-transitory computer readable medium of claim 15, wherein the VNF package includes one or more VNFC software loads.

19. The non-transitory computer readable medium of claim 15, wherein the traditional VNF package components are stored in the VNF Catalog.

20. The non-transitory computer readable medium of claim 15, wherein the one or more VNFC components are a reference to an artifact stored in an external database.
